(19) United States
(12) Patent Application Publication
(10) Pub. No.: US 2008/0276969 A1
(43) Pub. Date: Nov. 13, 2008

(54) APPLIANCE WITH UNIQUE LOCKING RECEPTACLES

(75) Inventors: TIMOTHY PATRICK VANANTWERP, ST. JOSEPH, MI (US); TIMOTHY NICHOLAS AYKROYD, BROOKLINE, MA (US); MICHAEL STEPHEN HENDRICKSON, ST. JOSEPH, MI (US); JOEL ADAM LUCKMAN, BENTON HARBOR, MI (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 11/744,913

(22) Filed: May 7, 2007

(51) Int. Cl. D06F 39/02; A47L 15/44; B08B 3/04; B08B 3/08; D06F 58/20; B08B 7/04; D06F 29/00; D06F 33/00

(52) U.S. Cl. 134/25.1; 68/12.18

(57) ABSTRACT

A substrate treating appliance utilizing a plurality of different chemistries for different cycles or different wash loads with a plurality of receptacles for receiving a plurality of cartridges containing the different chemistries. Each receptacle has one half of a lock and key connection arrangement providing a unique interconnection configuration at each receptacle, relative to the remaining receptacles, permitting only a selected type of chemistry cartridge to be accepted at a particular receptacle. A connection effected between the cartridge and the receptacle occurs by rotation of the cartridge relative to the receptacle between an insertion orientation and a locking orientation. Each receptacle is shaped to receive a cylindrical mouth wall of a particular type of chemistry cartridge. Each receptacle may also be uniquely sized, relative to the remaining receptacles, to accept only a selected type of chemistry cartridge. The plurality of receptacles may be arranged adjacent to one another with each cartridge having a configuration that prevents insertion of a cartridge into a receptacle unless every cartridge located in an adjacent receptacle is rotated to the locking orientation.

### BACKGROUND OF THE INVENTION

In appliances that are used to treat various substrates, such as laundry appliances that treat fabrics and dishwashers that treat dishware, oftentimes different chemistries are added to the appliance during different treatment cycles or at different times during a given treatment cycle, depending on the treatment function to be performed, and depending on the item being treated, for example. It is known to provide different containers containing different chemistries, such that during operation of the appliance, the appropriate chemistries can be selected and introduced to the appliance.

For example, in U.S. Pat. No. 6,691,536, a washing apparatus is provided with various tanks 19, 20, 27 and 28 that can contain selected chemistries. The tanks may be permanently installed, or may be removable and replaceable, such as for replacement with a fresh tank, or refilled with fresh chemistry. The patent doesn't illustrate, but suggests that each tank may comprise a physical configuration such that it is attachable and detachable from the apparatus in a “lock and key” manner. In other words, a tank fits selectively into an intended “receiving port” or receptacle of the apparatus.

In published application US2006/0107705, a stand-alone dispensing device for laundry care composition is provided with a plurality of containers 40 for selected chemistry products. The containers may be removable and replaceable. The application doesn't illustrate, but suggests that the shape of the containers and the corresponding interlocking slots are shaped differently to prevent misplaced installation of products. The application also suggests that misplaced installation may be prevented via color or shape or size differentiation with common interlocks.

It would be an improvement in the art if there were provided an arrangement for assuring that the arrangement provide a clear and unmistakable indication to the user that the correct receptacle has been chosen for a particular cartridge, that appropriate chemistry cartridges are being inserted into appropriate receptacles for the particular chemistries in a given cartridge, and that the arrangement prevent insertion of a cartridge unless other inserted cartridges have been completely inserted and locked to their receptacle.

### SUMMARY OF THE INVENTION

In an embodiment of the invention, the present invention provides a substrate treating appliance utilizing a plurality of different chemistries for different treatment cycles or different wash loads with a plurality of receptacles for receiving a plurality of cartridges containing the different chemistries. One half of a lock and key connection arrangement is provided at each receptacle providing a unique interconnection configuration at each receptacle, relative to the remaining receptacles, permitting only a selected type of chemistry cartridge to be accepted at a particular receptacle. A connection effected between the cartridge and the receptacle occurs by means of a rotation of the cartridge relative to the receptacle. Each receptacle is shaped to receive a cylindrical mouth wall of a particular type of chemistry cartridge. Each receptacle is also provided with a unique characteristic, in addition to the unique interconnection configuration, relative to the remaining receptacles, to alert and guide a user to insert the correct type of chemistry cartridge into a particular receptacle.

In an embodiment, one half of the lock and key arrangement at each receptacle comprises one or more slots in each receptacle arranged to receive one or more projections located on the cylindrical mouth wall of the cartridges.

In an embodiment, the substrate treating appliance comprises one of a clothes washer, a clothes refresher, a clothes dryer and a dishwasher.

In an embodiment, a locking detent arrangement is provided at each receptacle to lock the cartridge to the receptacle upon a predetermined rotation of the cartridge relative to the receptacle.

In an embodiment, the locking detent arrangement causes the cartridge to lock to the receptacle upon a 90 degree rotation of the cartridge relative to the receptacle.

In an embodiment, a stop wall is provided at each receptacle to prevent the cartridge from being rotated beyond a predetermined rotational amount relative to the receptacle.

In an embodiment, the unique characteristic comprises one of size or color of the receptacle, as well as the cartridge.

In an embodiment, the plurality of receptacles are provided adjacent to one another.

In an embodiment of the invention, a system is provided for a substrate treating appliance utilizing a plurality of different chemistries for different treatment cycles or different wash loads. The system includes a plurality of cartridges containing the different chemistries and a plurality of receptacles for receiving the plurality of cartridges. One half of a lock and key connection arrangement is provided at each receptacle providing a unique interconnection configuration at each receptacle, relative to the remaining receptacles, permitting only a selected type of chemistry cartridge to be accepted at a particular receptacle. A connection effected between the cartridge and the receptacle occurs by means of a rotation of the cartridge relative to the receptacle between an insertion orientation and a locking orientation. The plurality of receptacles are arranged adjacent to one another and each cartridge has a configuration that prevents insertion of a cartridge into a receptacle unless every cartridge located in an adjacent receptacle is rotated to the locking orientation.

In an embodiment, each receptacle is shaped to receive a cylindrical mouth wall of a particular type of chemistry cartridge, and is uniquely sized, relative to the remaining receptacles, to accept only a selected type of chemistry cartridge.

In an embodiment, each cartridge is provided with a projection that protrudes laterally beyond an extent of a remainder of the cartridge, which projection interferes with the projection of an adjacent cartridge unless the adjacent cartridge is rotated to the locking orientation.

In an embodiment, the projection is a handle.

In an embodiment of the invention, a method of supplying a substrate treating appliance with a plurality of different chemistries for different treatment cycles or different wash loads is provided. The method includes the steps of:

providing a plurality of cartridges containing the different chemistries, each with a cylindrical mouth wall through which the chemistry in the cartridge is dispensed to the substrate treating appliance, and each cylindrical mouth wall sized to correspond with the particular type of chemistry contained in that cartridge,

providing a plurality of receptacles for receiving the cylindrical mouth wall of a particular one of the plurality of cartridges,

sizing a diameter of each receptacle uniquely relative to the remaining receptacles to accept the cylindrical mouth wall of only a selected type of chemistry cartridge,

providing one half of a lock and key connection arrangement at each receptacle providing a unique interconnection configuration at each receptacle, relative to the remaining receptacles, permitting only a selected type of chemistry cartridge to be accepted at a particular receptacle,

providing a second half of the lock and key connection arrangement at each cartridge configured to be accepted only at a selected receptacle, and

inserting each cartridge into its particular receptacle with a first axial insertion motion and then a rotational locking motion until the cartridge reaches a locking orientation.

In an embodiment, the invention includes the further steps of arranging the plurality of receptacles adjacent to one another, and configuring each cartridge to prevent insertion of a cartridge into a receptacle unless every cartridge located in an adjacent receptacle is rotated to the locking orientation.

In an embodiment, the step of configuring each cartridge comprises providing each cartridge with a projection that protrudes laterally beyond an extent of a remainder of the cartridge, which projection interferes with the projection of an adjacent cartridge unless the adjacent cartridge is rotated to the locking orientation.

In an embodiment, the step of configuring each cartridge comprises providing each cartridge with a handle that protrudes laterally beyond an extent of a remainder of the cartridge, which handle interferes with the handle of an adjacent cartridge unless the adjacent cartridge is rotated to the locking orientation.

In an embodiment, blanks with the lock and key can be provided as a kit if the user chooses to use/load a limited number of cartridges fewer than the maximum possible cartridges.

### BRIEF DESCRIPTION OF THE DRAWING

FIG. 1 is a schematic view of a substrate treating appliance incorporating a cartridge and receptacle assembly embodying the principles of the present invention.

FIG. 2 is a partial perspective view of a series of receptacles and a first cartridge being inserted.

FIG. 3 is a partial perspective view of the series of receptacles of FIG. 1, showing a rotation of the inserted cartridge to a locking orientation.

FIG. 4 is a partial perspective view of the series of receptacles of FIG. 3, with a second cartridge being inserted.

FIG. 5 is a side elevational view of the series of receptacles of FIG. 4, showing the impermissible orientation of two adjacent cartridges in an insertion orientation.

FIG. 6 is a perspective view of a series of cartridges having differing diameter mouth cylindrical walls.

FIG. 7 is a plan view of a series of receptacles having differing lock and key configurations.

FIG. 8 is an enlarged perspective view of a receptacle in isolation.

### DETAILED DESCRIPTION OF THE PREFERRED EMBODIMENTS

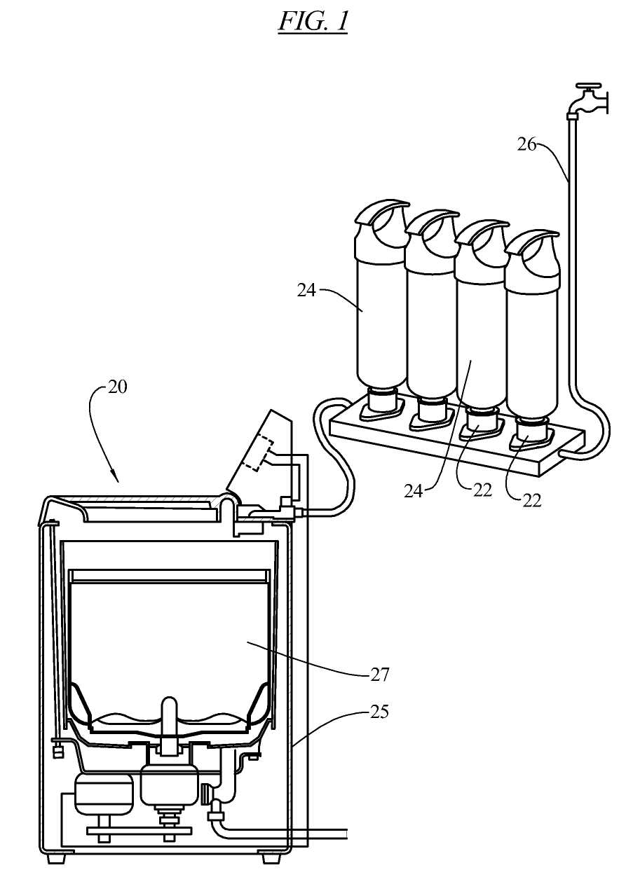

In an embodiment of the invention, as shown in FIG. 1, the present invention provides a substrate treating appliance 20 utilizing a plurality of different chemistries for different cycles or different wash loads with a plurality of receptacles 22 for receiving a plurality of cartridges 24 containing the different chemistries. While FIG. 1 shows the appliance 20 to be in the form of a vertical axis clothes washer, other types of clothes washers, such as horizontal or tilted axis washer, as well as other types of substrate treating appliances may also incorporate the present invention, such as clothes refreshers, clothes dryers or dishwashers. Also, two or more receptacles 22 may be provided, however, in the drawings, four receptacles are shown. The different chemistries that may be provided, in a clothes washer, for example, include pre-wash chemistries, wash detergents, bleaches or other oxidizing chemistries, fabric softeners, water softeners, fragrances, anti-static agents, drying aids, de-wrinkling chemistries, deodorizers, etc. Other types of substrate treating appliances may utilize different or similar chemistries. The chemistries may be selected and dispensed singly or in various combinations, as selected by the user or as selected by a preprogrammed washing operation of the appliance 20.

The cartridges may contain between 50 and 1000 ml of the appropriate chemistries, more preferably 300 to 800 ml. Additionally instead of volume, the cartridges can contain between 1 and 50 loads of chemistries and more preferably between 5 and 30 loads of chemistries. The cartridges 24 themselves may be constructed from materials compatible with a the range of chemistries to be contained such as non-ferrous materials such as aluminum, composite materials such as carbon, glass or plastics such as polyvinylchloride, polyethylene, high density polyethylene, polystyrene, polypropylene and mixtures thereof. Tubing and other materials can be constructed from silicone or rubber materials.

The receptacles 22 may be located inside a cabinet 25 of the appliance 20, or they may be located outside of the cabinet in some arrangements, in order to facilitate removal and replacement of the cartridges 24, or due to space considerations.

The cartridges 24 themselves can replace the current dispensing systems on front loading or top loading washing machines. They could also be located in a folding down user interface, in the toe-panel for front loading washing machines, in the top of front loading washing machines, within the baffles used for agitation of the wash load, reflected over the vertical axis of symmetry (moved to the top right corner) for today's dispensers or in the door, accessible internal or external to the door. For the dryer, the cartridge(s) 24 may be located internal or external to the door, in the same location as typical front-loading washing machines today (top-left corner), on top of the dryer, in the toe-panel, in the user interface or in the top-right corner. For top-loading washing machines, the cartridge(s) 24 could be in a similar location to front loading machines, in the front panel of the machines, in the side panels, in the lid or near or in the user interface. For dishwashers, the location may be internal or external to the door or in the user interface.

The receptacles 22 may be in communication with a single fluid conduit 26, or a series of separate dedicated conduits, in order to carry the chemistry from a selected one or more cartridges 24 to a wash zone 27 of the appliance 20 through one or more nozzles or liquid outlets. The fluid conduit 26 might carry water, or some other fluid used in the wash system. Appropriate valves or similar mechanisms are associated with each of the receptacles 22 to selectively dispense the chemistries. The appliance 20 may be provided with a control that communicates with the receptacles 22 to selectively open and close a valve in the receptacle to selectively dispense the chemistry contained in the cartridge.

In some arrangements, as schematically shown in FIG. 1, the receptacles 22 may be provided on a manifold housing 29 that is connected to the fluid conduit 26. In other arrangements, the receptacles 22 may be individually mounted and individually connected to the fluid conduit 26.

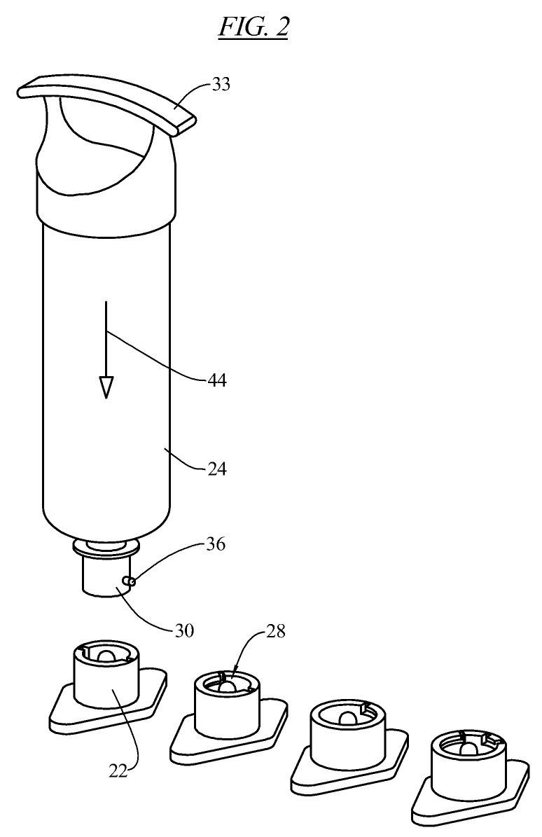

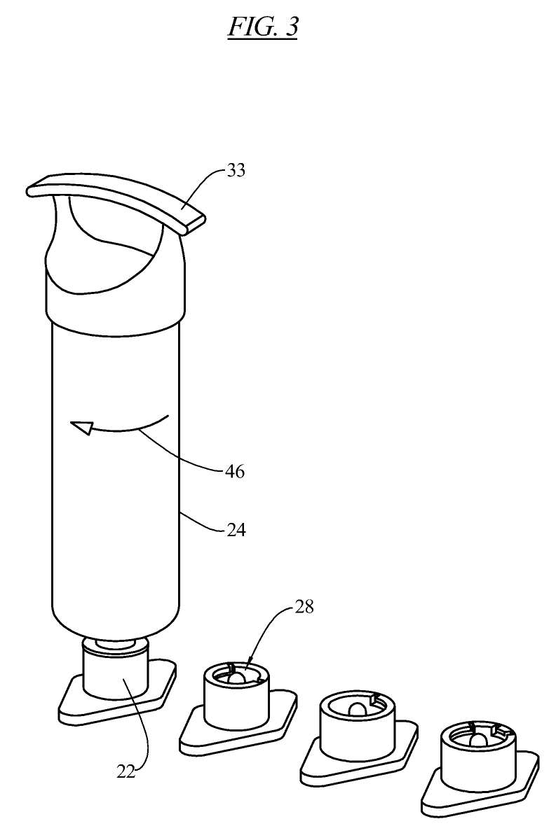

As shown in FIGS. 2-5 and 7-8, a first half of a lock and key connection arrangement 28 is provided at each receptacle 22 providing a unique interconnection configuration at each receptacle, relative to the remaining receptacles, permitting only a selected type of chemistry cartridge 24 to be accepted at a particular receptacle. In this manner, each type of chemistry will have a unique cartridge interconnection configuration, and will be able to be connected to only one of the receptacles 22. A connection effected between the cartridge 24 and the receptacle 22 occurs by means of an axially directed insertion of the cartridge 24 into the receptacle, as shown in FIG. 2, and then a rotation of the cartridge relative to the receptacle, as shown in FIG. 3, from an insertion orientation to a locking orientation. Although rotation around the insertion axis is illustrated, rotation of the cartridge 24 relative to the receptacle 22 could be around other axes.

In an embodiment, blanks, instead of actual cartridges 24, with the first half of the lock and key arrangement 28 can be provided as a kit if the user chooses to use/load a limited number of cartridges, fewer than the total number of receptacles.

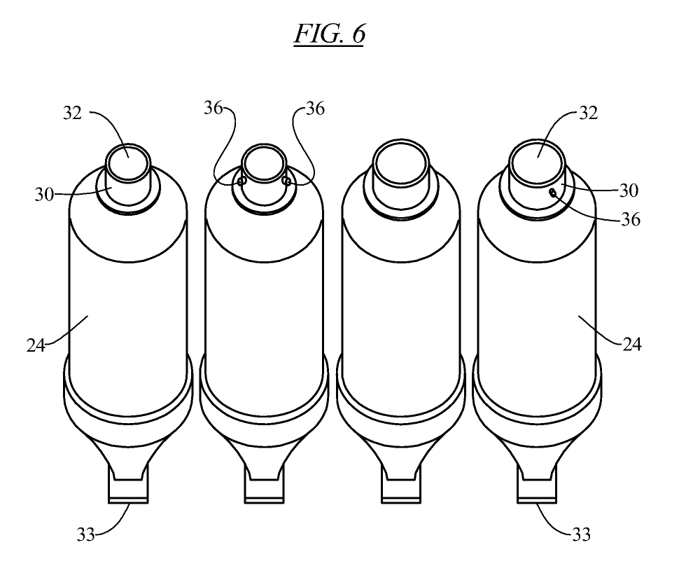

Each receptacle 22 is shaped to receive a cylindrical mouth wall 30 (FIG. 6) of a cartridge 24 for a particular type of chemistry. Typically the chemistry is dispensed through an open end 32 of the cylindrical mouth wall 30, although openings may be provided at different locations in the mouth wall.

In an embodiment, each receptacle 22 may also have a unique characteristic relative to the remaining receptacles, to alert and guide a user to insert the correct type of chemistry cartridge 24 into a particular receptacle. In this manner, a user will be guided to insert the correct cartridge 24 into the correct receptacle 22 and also, the cartridge will not be accepted unless it is in fact placed into the correct receptacle due to the unique interconnection configuration at each receptacle.

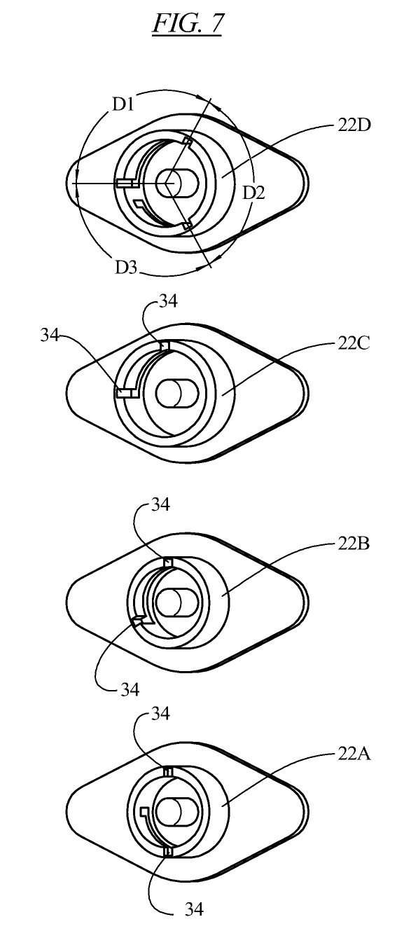

For example, as shown in FIG. 7, each of the receptacles 22 is provided with a different sized diameter. The various cartridges 24, as shown in FIG. 6 are also provided with different sized diameters of the cylindrical mouth wall 30. In this manner, a user with a given cartridge 24 will be provided with a clear and unmistakable indication of the correct receptacle 22 by the size of the receptacle, which will either be too small to accept the cartridge, be too large, thereby not allowing the locking of the cartridge onto the receptacle because of the loose fit, or just the right size.

Further, only the proper cartridge 24 will be able to be inserted and locked into the correct receptacle 22 due to the unique interconnection configuration of the lock and key connection arrangement 28, relative to the other receptacles, providing a second indication to the user that the correct cartridge is being inserted into the selected receptacle. Another unique characteristic could be the color of the receptacles and cartridges, such that the user would be guided to insert a cartridge of a particular color into a receptacle of the same color. Other unique characteristics could be provided as well. Further, the receptacle could provide other visual or audible feedback to the user confirming the correct insertion and locking of a cartridge to the receptacle, or indicating an incorrect cartridge or unlocked condition. Such visual or audible feedback could include indicator lights, buzzers, or other visual or audible devices as are well known.

To create a ‘smarter’ lock that is harder to crack, instead of relying on mechanical interactions to unlock the receptacle 22/cartridge 24 combination, digital data exchange can be the enabler. In this embodiment, cartridges 24 or bottles can carry or house a chip, bar, or other data storage module embedded with digital keys (commonly known as signatures). The embedded data is deciphered and communicated to a microcontroller in the machine control by a physical reader, located in the dispenser or anywhere in the machine. The microcontroller then knows whether or not the docked cartridge 24 is acceptable (i.e. authenticates the cartridge) and can decide what to do next based on its internal algorithms. The digital signature can have varying levels of security logic and cryptographic algorithms built in such that it is very secure and difficult to copy. In addition to the digital signature that ensures the authenticity of the bottle/cartridge 24, the data chip can contains a myriad of specific information about its makeup (such as type of chemistry housed, date of manufacturer, recommended dosing volumes) that may be useful for the machine or user (via machine's user interface) to know and may directly or indirectly influence machine cycles. Even machine or cycle software updates not related to the chemistry dispensing system can be transmitted to the microcontroller, making the dispenser/cartridge area a general interface for the entire machine.

Types of digital data exchange technologies include integrated circuit cards (ICC, often referred to as smart cards), magnetic stripe cards (similar to credit cards), and radio frequency identification (RFID) tags. The flexibility and physical implementation of these technologies vary greatly. For example conventional smart cards require that electrical connectors directly touch to transfer data to a reader; magnetic stripe cards also require direct contact with a reader. Contactless smart cards and RFID tags use inductive and radio wave technology to transmit data without a direct connection. Also, smart cards usually have writable memory whereas RFID devices usually do not, making it possible for smart card cartridges to receive data (such as number of cycles performed, time elapsed since last cycle, etc.) from the machine and store it for future reference. It should be noted that optical data exchange devices, such as barcodes and associated readers, can be used to identify and read data from cartridges but they do not have the security capability of the other aforementioned technologies

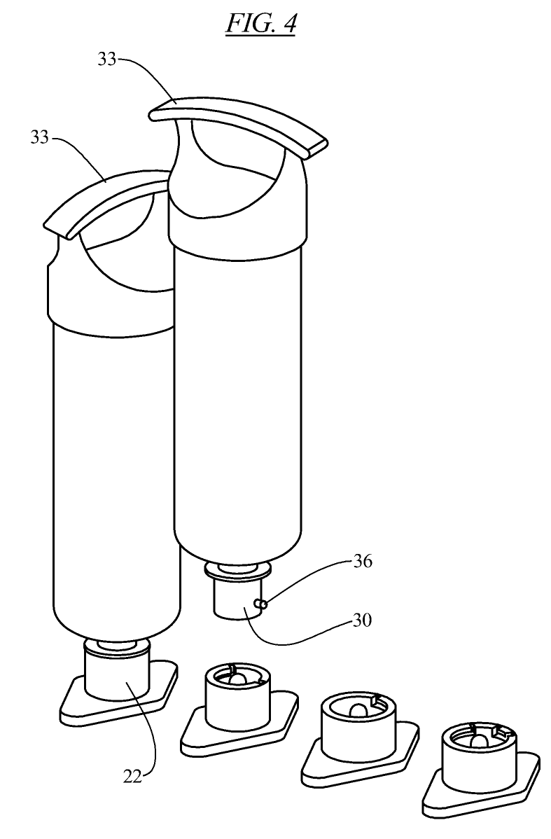

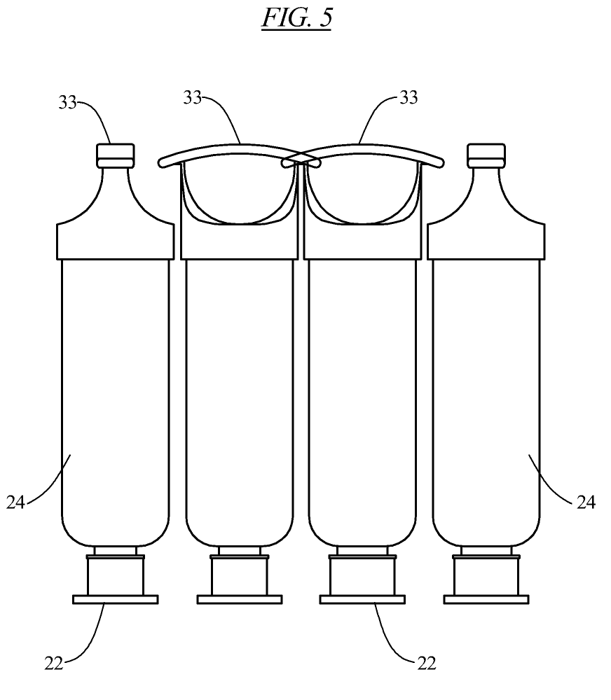

In an embodiment, as shown in FIGS. 1-4, the plurality of receptacles 22 may be arranged adjacent to one another. FIG. 4 shows a second, cartridge 24 being inserted into its receptacle 22, in the insertion orientation, adjacent to a first cartridge that has been rotated to the locking orientation. Each cartridge 24 may have a configuration that prevents insertion of a cartridge into a receptacle unless every cartridge located in an adjacent receptacle is already rotated to the locking orientation. As an example, each cartridge 24 may be provided with a projection 33 that protrudes laterally beyond an extent of a remainder of the cartridge. The projection 33 may be a handle for the cartridge 24, or it may be the shape of the cartridges shown in FIG. 5, the handles 33 of the two center adjacent cartridges 24 are positioned in an interfering relationship when two adjacent cartridges are positioned in the insertion orientation, rather than at least one being positioned in the locking orientation. Thus, the third cartridge 24 would not be able to be inserted into the third receptacle 22 when the second cartridge is still in the insertion orientation, and not rotated to the locking orientation.

A similar interference could be provided based on a shape of the cartridges 24, such as with the provision of oval shaped cartridges, such that a second cartridge would be prevented from being inserted into its receptacle 22 unless a first, adjacent cartridge is properly inserted and rotated to its locking orientation first. Such an arrangement will assure that each of the cartridges 24 is properly located and locked to its proper receptacle. The provision of the projection 33 will also give a visual indication to the user of the proper orientation for insertion of the cartridge into the receptacle as well as whether all of the cartridges are oriented properly before use of the appliance is begun.

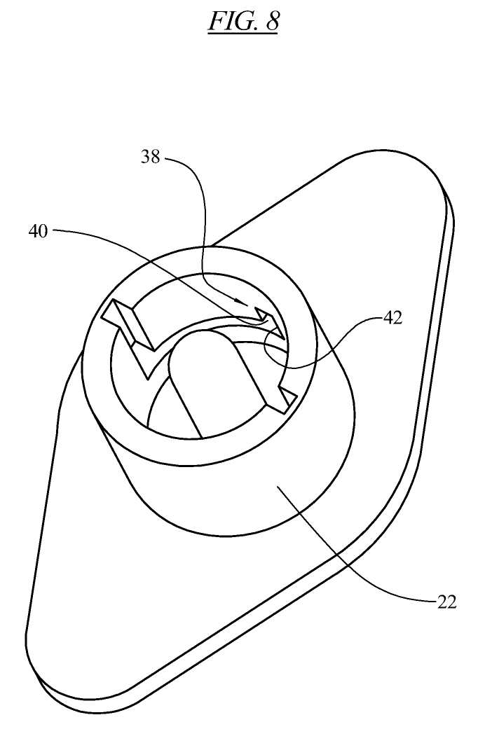

In an embodiment, the first half of the lock and key arrangement 28 at each receptacle 22 comprises one or more slots 34 (FIGS. 7 and 8) in each receptacle arranged to receive one or more projections 36 located on the cylindrical mouth wall 30 of the cartridges. As shown in FIG. 7, a first receptacle 22A has two slots 34 angularly spaced at 180 degrees from each other. A second receptacle 22B has three slots 34 angularly spaced at 120 degrees from each other. A third receptacle 22C has two slots 34 angularly spaced at 90 degrees from each other. A fourth receptacle 22D has three slots 34 angularly spaced from each other at angles D1, D2 and D3, such that none of D1, D2, D3, D1+D2, D1+D3 or D2+D3 equal 90, 120 or 180 degrees. In this way, the cartridges 24 that have only two projections 36 will not be able to be received in the receptacles having three slots 34.

In other embodiments, the lock and key arrangement 28 may comprise one or more slots or grooves in the exterior of the cylindrical mouth wall 30 of the cartridge and a corresponding one or more projections in the receptacle 22. Other lock and key arrangements, as are known in the art, could also be employed.

In an embodiment, as best seen in FIG. 8, a locking detent arrangement 38 is provided at each receptacle 22 and each cartridge 24 to lock the cartridge to the receptacle upon a predetermined rotation of the cartridge relative to the receptacle. The locking detent arrangement 38 may comprise an interlocking projection 36 and recess 40, one half of which is positioned on the cartridge 24, such as being or on one or more of the projections 36, and one half of which is formed in the receptacle 22. A spring or some type of resilient material may be positioned between the cartridge 24 and the receptacle 22 to bias or load the projection 36 into the recess 40. The locking detent arrangement 38 may also comprise a friction fit resulting from a camming action between the cartridge 24 and the receptacle 22. Other types of detent arrangements, as are known in the art, may also be used.

In an embodiment, the locking detent arrangement causes the cartridge 24 to lock to the receptacle upon a 90 degree rotation of the cartridge relative to the receptacle 22. Other angular rotations may be selected as well.

In an embodiment, a stop wall 42 is provided at each receptacle 22 to prevent the cartridge 24 from being rotated beyond a predetermined rotational amount relative to the receptacle. The stop wall 42 may be provided to engage with a portion of the cylindrical mouth wall 30 of the cartridge 24, such as the projection 36, or some other portion of the cartridge, such as on a shoulder or sidewall of the cartridge.

In an embodiment of the invention, a method of supplying the substrate treating appliance 20 with a plurality of different chemistries for different cycles or different wash loads is provided. The method includes the steps of:

providing the plurality of cartridges 24 containing the different chemistries, each with the cylindrical mouth wall 30 through which the chemistry in the cartridge is dispensed to the appliance 20, and each cylindrical mouth wall sized to correspond with the particular type of chemistry contained in that cartridge,

providing the plurality of receptacles 22 for receiving the cylindrical mouth wall 30 of a particular one of the plurality of cartridges 24,

sizing a diameter of each receptacle 22 uniquely relative to the remaining receptacles to accept the cylindrical mouth wall 30 of only a selected type of chemistry cartridge 24 (FIG. 7),

providing one half of the lock and key connection arrangement 28 at each receptacle 22 providing a unique interconnection configuration at each receptacle, relative to the remaining receptacles, permitting only a selected type of chemistry cartridge 24 to be accepted at a particular receptacle,

providing a second half of the lock and key connection arrangement 28 at each cartridge 24 configured to be accepted only at a selected receptacle 22, and

inserting each cartridge 24 into its particular receptacle with a first axial insertion motion (FIG. 2 arrow 44) and then a rotational locking motion (FIG. 3 arrow 46) until the cartridge reaches a locking orientation.

In an embodiment, the invention includes the further steps of arranging the plurality of receptacles 22 adjacent to one another, and configuring each cartridge 24 to prevent insertion of a cartridge into a receptacle unless every cartridge located in an adjacent receptacle is rotated to the locking orientation.

In an embodiment, the step of configuring each cartridge 24 comprises providing each cartridge with the projection 33, such as a handle, that protrudes laterally beyond an extent of a remainder of the cartridge, which projection interferes with the projection of an adjacent cartridge unless the adjacent cartridge is rotated to the locking orientation.

Various features of the receptacles and cartridges have been described which may be incorporated singly or in various combinations into a desired system, even though only certain combinations are described herein. The described combinations should not be viewed in a limiting way, but only as illustrative examples of particular possible combinations of features.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

The embodiments of the invention in which an exclusive property or privilege is claimed are defined as follows:

1. A substrate treating appliance utilizing a plurality of different chemistries for different cycles or different wash loads with a plurality of receptacles for receiving a plurality of cartridges containing the different chemistries, comprising:
one half of a lock and key connection arrangement provided at each receptacle providing a unique interconnection configuration at each receptacle, relative to the remaining receptacles, permitting only a selected type of chemistry cartridge to be accepted at a particular receptacle, with a connection effected between the cartridge and the receptacle occurring by means of a rotation of the cartridge relative to the receptacle,
each receptacle having a unique characteristic, in addition to the unique interconnection configuration, relative to the remaining receptacles, to alert a user to insert only a correct type of chemistry cartridge into a particular receptacle.

2. The substrate treating appliance of claim 1, wherein the one half of the lock and key arrangement at each receptacle comprises one or more slots in each receptacle arranged to receive one or more projections located on the cylindrical mouth wall of the cartridges.

3. The substrate treating appliance of claim 1, wherein the appliance comprises one of a clothes washer, a clothes refresher, a clothes dryer and a dish washer.

4. The substrate treating appliance of claim 1, wherein a locking detent arrangement is provided at each receptacle to lock the cartridge to the receptacle upon a predetermined rotation of the cartridge relative to the receptacle.

5. The substrate treating appliance of claim 4, wherein the locking detent arrangement causes the cartridge to lock to the receptacle upon a 90 degree rotation of the cartridge relative to the receptacle.

6. The substrate treating appliance of claim 1, wherein a stop wall is provided at each receptacle to prevent the cartridge from being rotated beyond a predetermined rotational amount relative to the receptacle.

7. The substrate treating of claim 1, wherein the unique characteristic is one of size and color.

8. A system for use with a substrate treating appliance utilizing a plurality of different chemistries for different cycles or different wash loads, comprising:
a plurality of cartridges containing the different chemistries,
a plurality of receptacles arranged adjacent to one another for receiving the plurality of cartridges,
one half of a lock and key connection arrangement provided at each receptacle providing a unique interconnection configuration at each receptacle, relative to the remaining receptacles, permitting only a selected type of chemistry cartridge to be accepted at a particular receptacle, with a connection effected between the cartridge and the receptacle occurring by means of a rotation of the cartridge relative to the receptacle between an insertion orientation and a locking orientation,
each cartridge having a configuration that prevents insertion of a cartridge into a receptacle unless every cartridge located in an adjacent receptacle is rotated to the locking orientation.

9. The system of claim 8, wherein each receptacle is shaped to receive a cylindrical mouth wall of a particular type of chemistry cartridge, and being uniquely sized, relative to the remaining receptacles, to accept only a selected type of chemistry cartridge.

10. The system of claim 8, wherein each cartridge is provided with a handle that protrudes laterally beyond an extent of a remainder of the cartridge, which handle interferes with the handle of an adjacent cartridge unless the adjacent cartridge is rotated to the locking orientation.

11. The system of claim 8, wherein each cartridge is provided with a projection that protrudes laterally beyond an extent of a remainder of the cartridge, which projection interferes with the projection of an adjacent cartridge unless the adjacent cartridge is rotated to the locking orientation.

12. The system of claim 8, wherein the one half of the lock and key arrangement at each receptacle comprises one or more slots in each receptacle arranged to receive one or more projections located on the cylindrical mouth wall of the cartridges.

13. The system of claim 8, wherein the substrate treating appliance comprises one of a clothes washer, a clothes refresher, a clothes dryer and a dishwasher.

14. The system of claim 8, wherein a locking detent arrangement is provided at each receptacle to lock the cartridge to the receptacle upon a predetermined rotation of the cartridge relative to the receptacle.

15. The system of claim 14, wherein the locking detent arrangement causes the cartridge to lock to the receptacle upon a 90 degree rotation of the cartridge relative to the receptacle.

16. The system of claim 8, wherein a stop wall is provided at each receptacle to prevent the cartridge from being rotated beyond a predetermined rotational amount relative to the receptacle.

17. A method of supplying a substrate treating appliance with a plurality of different chemistries for different treatment cycles or different wash loads, comprising:
providing a plurality of cartridges containing the different chemistries, each with a cylindrical mouth wall through which the chemistry in the cartridge is dispensed to the substrate treating appliance, and each cylindrical mouth wall sized to correspond with the particular type of chemistry contained in that cartridge,
providing a plurality of receptacles for receiving the cylindrical mouth wall of a particular one of the plurality of cartridges,
sizing a diameter of each receptacle uniquely relative to the remaining receptacles to accept the cylindrical mouth wall of only a selected type of chemistry cartridge,
providing one half of a lock and key connection arrangement at each receptacle providing a unique interconnection configuration at each receptacle, relative to the remaining receptacles, permitting only a selected type of chemistry cartridge to be accepted at a particular receptacle,
providing a second half of the lock and key connection arrangement at each cartridge configured to be accepted only at a selected receptacle,
inserting each cartridge into its particular receptacle with a first axial insertion motion and then a rotational locking motion until the cartridge reaches a locking orientation.

18. The method of claim 17, including the steps of
arranging the plurality of receptacles adjacent to one another, and
configuring each cartridge to prevent insertion of a cartridge into a receptacle unless every cartridge located in an adjacent receptacle is rotated to the locking orientation.

19. The method of claim 18, wherein the step of configuring each cartridge comprises providing each cartridge with a projection that protrudes laterally beyond an extent of a remainder of the cartridge, which projection interferes with the projection of an adjacent cartridge unless the adjacent cartridge is rotated to the locking orientation.

20. The method of claim 18, wherein the step of configuring each cartridge comprises providing each cartridge with a handle that protrudes laterally beyond an extent of a remainder of the cartridge, which handle interferes with the handle of an adjacent cartridge unless the adjacent cartridge is rotated to the locking orientation.
